(19) United States
(12) Patent Application Publication
(10) Pub. No.: US 2019/0122159 A1
(43) Pub. Date: Apr. 25, 2019

(54) SERVICE DEPLOYMENT SYSTEM BASED ON SERVICE TICKET DATA MINING AND AGENT PROFILES

(71) Applicant: Intelenz, Inc., Union City, CA (US)

(72) Inventor: Renzo Zagni, Union City, CA (US)

(21) Appl. No.: 15/792,739

(22) Filed: Oct. 24, 2017

(51) Int. Cl. G06Q 10/06; G06F 17/30

(52) U.S. Cl. CPC G06Q 10/063112; G06F 2216/03; G06F 17/30528; G06F 17/30539

(57) ABSTRACT

Service deployment based on service ticket data mining and agent profiles can include: obtaining an agent profile for each of a set of service agents, each agent profile specifying a set of skills of the corresponding service agent; caching a set of service tickets each describing a corresponding service issue reported by a set of service clients of a service deployment system; subdividing the service tickets into a set of ticket groups by detecting one or more content patterns in the service tickets such that the content patterns are based on the skills of the service agents; and determining a recommendation of which the service tickets should be assigned to which of the service agents based on the ticket groups and the agent profiles.

### BACKGROUND

Often, in the context of a team of individuals of varying skills, one is faced with the problem of deciding which of the team members should perform which of a set of task assigned to the team. For example, when a team of repair technicians receives a large number of repair requests, one is faced with the problem of deciding which repair technicians should be assigned which repair requests.

One solution is to allow the individual team members to choose for themselves. For example, when a team of repair technicians receives a large number of repair requests, each individual repair technicians can be allowed to examine and select among the repair requests according to whatever criteria each individual chooses to apply to their selection.

Another solution is to assign one or more team members the job of assigning tasks to the team. For example, when a team of repair technicians receives a large number of repair requests, a manager of the team of repair technicians can examine and select which of the repair requests are to be assigned to which repair technician according to whatever criteria the manager chooses to apply to the job of assigning.

### SUMMARY

In general, in one aspect, the invention relates to a service deployment system based on service ticket data mining and agent profiles. The service deployment system can include: a data store for holding an agent profile for each of a set of service agents, each agent profile specifying a set of skills of the corresponding service agent; a cache of set of service tickets each describing a corresponding service issue reported by a set of service clients of the service deployment system; a data miner for subdividing the service tickets into a set of ticket groups by detecting one or more content patterns in the service tickets such that the content patterns are based on the skills of the service agents; and an agent mapper for determining a recommendation of which the service tickets should be assigned to which of the service agents based on the ticket groups and the agent profiles.

In general, in another aspect, the invention relates to a method for service deployment based on service ticket data mining and agent profiles. The method can include: obtaining an agent profile for each of a set of service agents, each agent profile specifying a set of skills of the corresponding service agent; caching a set of service tickets each describing a corresponding service issue reported by a set of service clients of a service deployment system; subdividing the service tickets into a set of ticket groups by detecting one or more content patterns in the service tickets such that the content patterns are based on the skills of the service agents; and determining a recommendation of which the service tickets should be assigned to which of the service agents based on the ticket groups and the agent profiles.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates the operation of a service deployment system based on service ticket data mining and agent profiles in one or more embodiments.

FIG. 2 illustrates a set of functional components of a service deployment system based on service ticket data mining and agent profiles in one or more embodiments.

FIG. 3A shows how a service deployment system based on service ticket data mining and agent profiles notifies a set of service agents of which of a set of cached service tickets are recommended.

FIG. 3B shows how a service deployment system based on service ticket data mining and agent profiles distributes a set of cached service tickets to a set of service agents.

FIG. 4 shows how a service deployment system based on service ticket data mining and agent profiles organizes a set of cached service tickets into a set of ticket groups by representing the service tickets in a graph structure.

FIG. 5 shows how a service deployment system based on service ticket data mining and agent profiles obtains a set of profile settings from a set of service agents in one or more embodiments.

FIG. 6 shows how a service deployment system based on service ticket data mining and agent profiles obtains a set of endorsements of service agent skills from a set of service clients in one or more embodiments.

FIG. 7 shows how a service deployment system based on service ticket data mining and agent profiles obtains a set of profile settings of service agents by data mining a service tickets history in one or more embodiments.

FIG. 8 shows how a service deployment system based on service ticket data mining and agent profiles refines a set of ticket groups in response to a service tickets history.

FIG. 9 shows how a service deployment system based on service ticket data mining and agent profiles refines a set of ticket groups in response to service agent feedback.

FIG. 10 illustrates a method for service deployment based on service ticket data mining and agent profiles for in one or more embodiments.

FIG. 11 illustrates a computing system upon which portions of a service deployment system based on service ticket data mining and agent profiles can be implemented.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

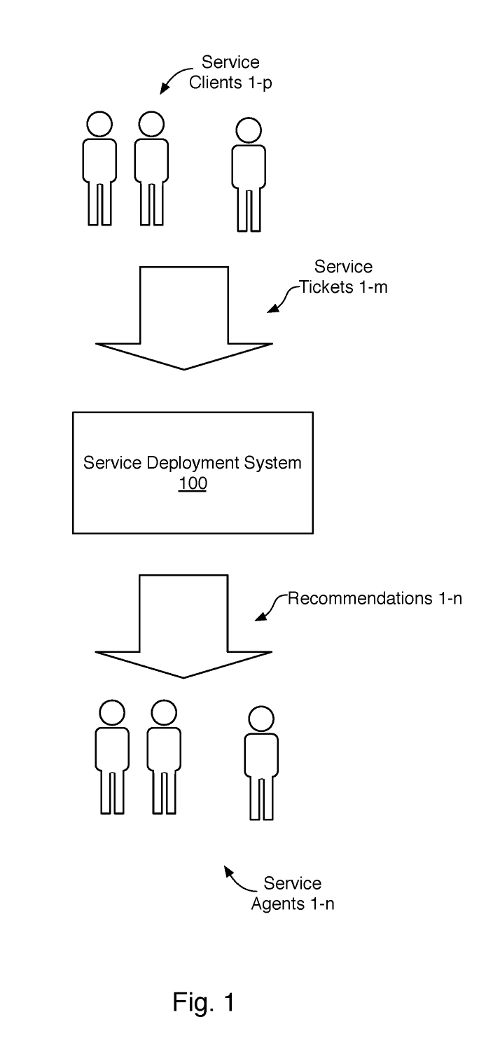

FIG. 1 illustrates the operation of a service deployment system 100 in one or more embodiments. The service deployment system 100 obtains a set of service tickets 1-m from a set of service clients 1-p of the service deployment system 100. Each service ticket 1-m describes one or more service issues to be handled by a set of service agents 1-n.

The service deployment system 100 generates a set of recommendations 1-n of which of the service agents 1-n should handle which of the service tickets 1-m. For example, the recommendation 1 indicates which of the service tickets 1-m should be assigned to the service agent 1, the recommendation 2 indicates which of the service tickets 1-m should be assigned to the service agent 2, etc.

The service agents 1-n can be any type of service agents. For example, the service agents 1-n can be technical support personnel, e.g., information technology troubleshooters for a corporation or other type of organization. In other examples, the service agents 1-n can be personnel of a human resources department of an organization, programmers in a software development team of a corporation or other type of organization, field service personnel, sales personnel, etc., to name just a few examples. The service clients 1-p can be employees, customers, etc., of a corporation or other type of organization serviced by the service agents 1-n.

The service deployment system 100 determines the recommendations 1-n by mining data from the service tickets 1-m and detecting patterns in the mined data that match the skills of the service agents 1-n. The service deployment system 100 in one or more embodiments mines the service tickets 1-m by employing one or more clustering techniques, e.g., spectral clustering, supervised learning techniques, unsupervised learning techniques, deep learning, collaborative filtering techniques, etc.

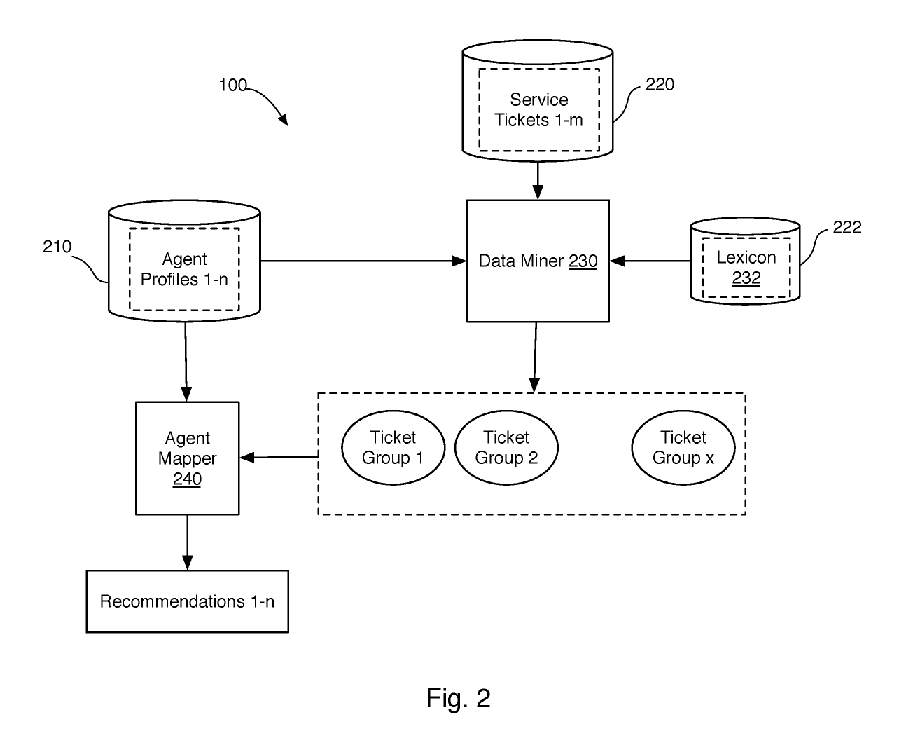

FIG. 2 illustrates a set of functional components of the service deployment system 100 in one or more embodiments. The service deployment system 100 includes a data store 210 for holding a set of agent profiles 1-n of the service agents 1-n. For example, the agent profile 1 corresponds to the service agent 1, the agent profile 2 corresponds to the service agent 2, etc.

Each agent profile 1-n specifies a set of skills of the corresponding service agent 1-n. Each agent profile 1-n can specify any number of skills. The skills in the agent profiles 1-n can include skills selected from a predetermined set of skills pertinent to a mission of a team in which the service agents 1-n are members.

For example, in an embodiment in which the service agents 1-n are personnel of a human resources department of a corporation, the skills specified in the agent profiles 1-n can include “employee benefits”, “health insurance”, “bonus structures”, “vacation policy”, “sexual harassment”, “employee reviews”, etc. In an example embodiment in which the service agents 1-n are information technology support personnel, the skills specified in the agent profiles 1-n can include “server hardware”, “desktop hardware”, “routers”, “networks”, “desktop software”, “mobile software”, etc. In an example embodiment in which the service agents 1-n are software engineers in a software development team, the skills specified in the agent profiles 1-n can include “Java”, “Objective-C”, “Python”, “SQL”, “mobile OS”, etc.

The service deployment system 100 includes a cache 220 of the service tickets 1-m. For example, in an embodiment in which the service agents 1-n are personnel of a human resources department of a corporation, the service tickets 1-m can include questions or describe problems or issues related to the field of human resources, e.g., benefits, pay, harassment, work environment issues, etc. In an example embodiment in which the service agents 1-n are information technology support personnel, the service tickets 1-m can include questions or describe problems or issues related to the information technology deployed in a corporation, e.g., hardware, software, training, upgrades, etc. In an example embodiment in which the service agents 1-n are members of a software development team, the service tickets 1-m can specify new coding projects or describe problems or issues related to existing software.

The service deployment system 100 includes a data miner 230 that subdivides the service tickets 1-m into a set of ticket groups 1-x by detecting one or more content patterns in the service tickets 1-m. In one or more embodiments, the content patterns are based on the skills specified in the agent profiles 1-n of the service agents 1-n.

The data miner 230 in one or more embodiments detects content patterns by recognizing keywords in the service tickets 1-m that are relevant to the skills specified in the agent profiles 1-n of the service agents 1-n. For example, in an embodiment in which the service agents 1-n are personnel of a human resources department, the data miner 230 can detect content patterns in the service tickets 1—by recognizing keywords relevant to human resources department skills, e.g., “health benefits”, “bonus structures”, “vacation policy”, “sexual harassment”, etc.

The data miner 230 in one or more embodiments detects content patterns by extracting a set of features from each of the service tickets 1-m. The features extracted from the service tickets 1-m can include words, phrases, or other information that correlates to the skills of the service agents 1-n specified in the agent profiles 1-n. The data miner 230 can use a variety of artificial intelligence techniques, e.g., natural language processing, to extract features from the service tickets 1-m.

In one or more embodiments, the data minter 230 accesses a lexicon 232 in a data store 222 to extract the features from the service tickets 1-m. For example, the lexicon 232 can include keywords, phrases, etc., adapted to the skills in the agent profiles 1-n.

The data miner 230 in one or more embodiments groups the service tickets 1-m into the ticket groups 1-x by applying clustering techniques, e.g., spectral clustering, to the features extracted from the service tickets 1-m. The data miner 230 can employ one or more of a variety of techniques including artificial intelligence techniques e.g., supervised learning, unsupervised learning, deep learning, collaborative filtering etc., to generate the ticket groups 1-x.

The service deployment system 100 includes an agent mapper 240 that determines the recommendations 1-n indicating which of the service tickets 1-m should be assigned to which of the service agents 1-n based on the content patterns of the ticket groups 1-x and the agent profiles 1-n. For example, if the agent profile 1 indicates that the service agent 1 is an expert in handling health benefit issues then the agent mapper 240 maps the ticket groups 1-x that are highly correlated to health benefit issues to the service agent 1. Likewise, if the agent profile 2 indicates that the service agent 2 is an expert in handling bonus structure issues then the agent mapper 240 maps the ticket groups 1-x that are highly correlated to bonuses issues to the service agent 2.

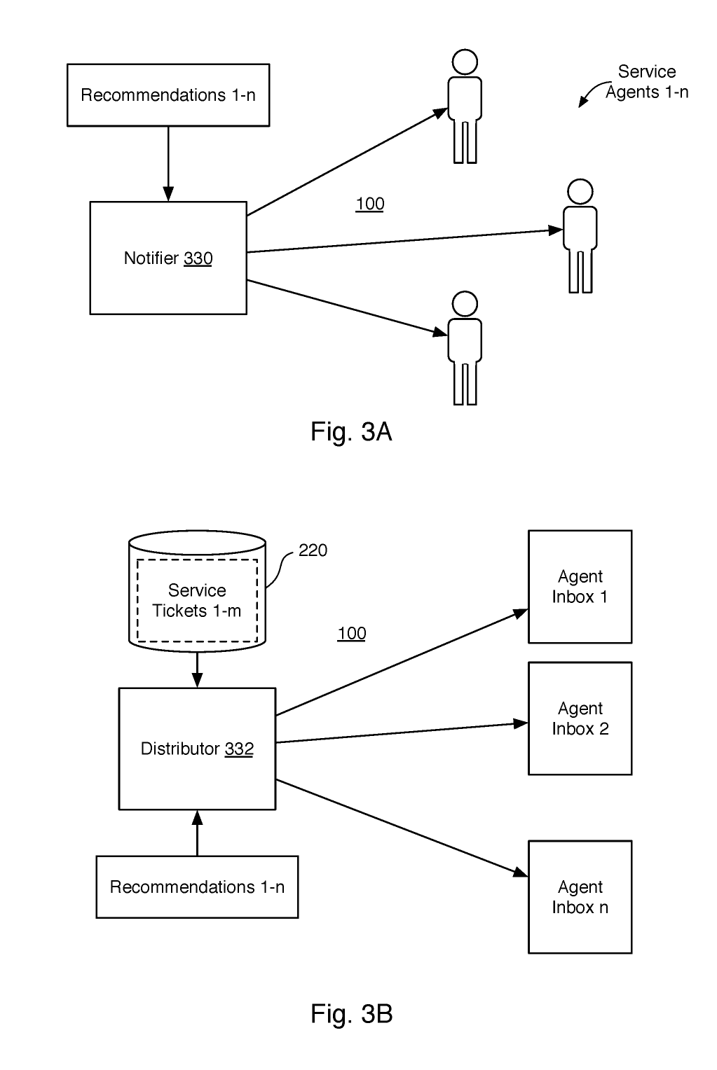

FIG. 3A illustrates a notifier 330 in one or more embodiments of the service deployment system 100. The notifier 330 notifies the service agents 1-n of which of the service tickets 1-m are recommended based on the recommendations 1-n. The notified service agents 1-n can then at their discretion retrieve their respective recommended service tickets 1-m from the cache 220.

FIG. 3B illustrates a distributor 332 in one or more embodiments of the service deployment system 100. The distributor 232 distributes the service tickets 1-m to a set of agent inboxes 1-n of the service agents 1-n based on the recommendations 1-n. For example, the distributor 232 can distribute the service tickets 1-m that map to the agent 1 to the agent inbox 1 in response to the recommendation 1.

In one or more embodiments, the service deployment system 100 obtains notify, distribute preferences from the service agents 1-n indicating whether or not the recommended service tickets 1-m should be distributed to the agent inboxes 1-n. For example, if the service agent 1 chooses the notify preference then the service agent 1 will only be notified of which of the service tickets 1-m are recommended, and if the service agent 1 chooses the distribute preference then the service tickets 1-m recommended for the service agent 1 will be distributed to the agent inbox 1.

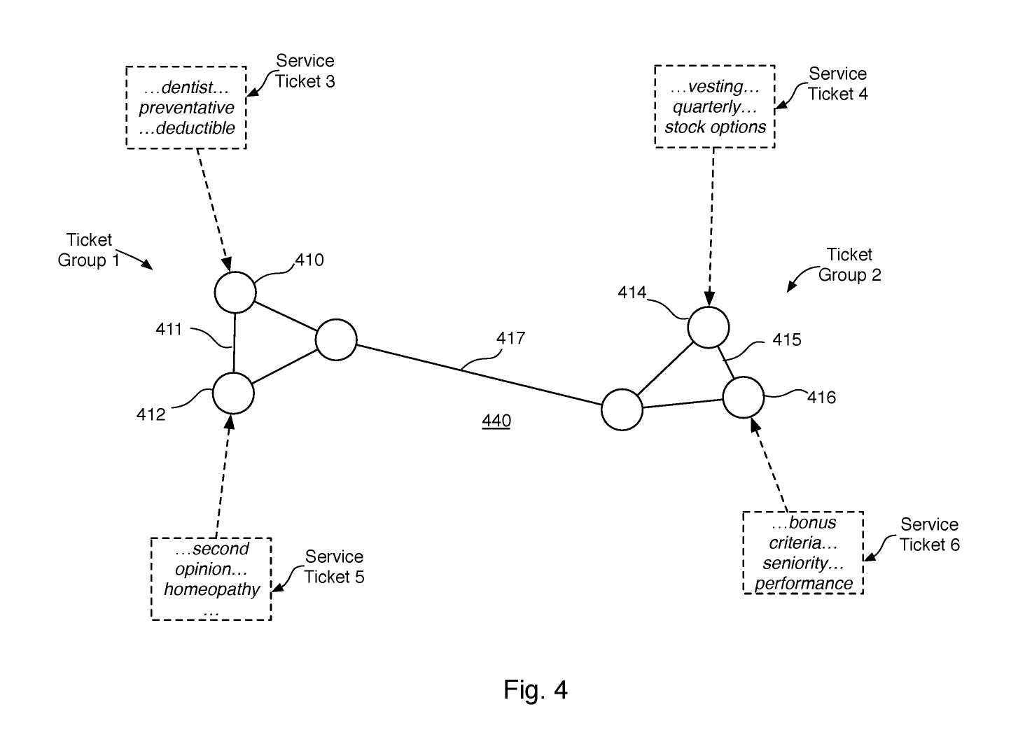

FIG. 4 shows an example of how in one or more embodiments the data miner 230 organizes the service tickets 1-m into the ticket groups 1-x by representing the service tickets 1-m in a graph structure 440. In this example, the ticket groups 1-x include a ticket group 1 and a ticket group 2.

The graph structure 440 includes a set of nodes each representing a corresponding one of the service tickets 1-m. For example, a node 410 represents the service ticket 3, a node 412 represents the service ticket 5, a node 414 represents the service ticket 4, and a node 416 represents the service ticket 6.

The graph structure 440 includes a set of interconnecting edges among the nodes each representing a similarity between the corresponding nodes. For example, an edge 411 represents a similarity between the service ticket 3 represented by the node 410 and the service ticket 5 represented by the node 412, and an edge 415 represents a similarity between the service ticket 4 represented by the node 414 and the service ticket 6 represented by the node 416.

The data miner 230 in one or more embodiments determines the edges in the graph structure 440 by extracting and comparing relevant features from the service tickets 1-m. In one or more embodiments, the data miner 230 extracts relevant features from the service tickets 1-m by detecting keywords in the service tickets 1-m that are relevant to the agent profiles 1-n of the service agents 1-n. The data miner 230 can extract relevant features from the service tickets 1-m by using natural language processing to detect features of the service tickets 1-m that are relevant to the agent profiles 1-n of the service agents 1-n.

For example, the data miner 230 can recognize the terms “dentist”, “preventative”, and “deductible” in the service ticket 3 as relevant to the health benefits skills in the agent profiles 1-n and recognize the terms “second opinion”, and “homeopathy” in the service ticket 5 as also relevant to the health benefits skills in the agent profiles 1-n. As a consequence, the edge 411 indicates a relatively high correlation between the service ticket 3 represented by the node 410 and the service ticket 5 represented by the node 412.

Similarly, the data miner 230 detects the terms “vesting”, “quarterly”, and “stock options” in the service ticket 4 and the terms “bonus criteria”, and “seniority”, and “performance” in the service ticket 6 as relevant to the bonus structure skills in the agent profiles 1-n. As a consequence, the edge 415 indicates a relatively high correlation between the service ticket 4 represented by the node 414 and the service ticket 6 represented by the node 416.

The relative dissonance between the extracted health benefits related features of the ticket group 1 and the extracted bonus structure related features of the ticket group 2 yield an edge 417 indicating a relatively low correlation between the service tickets represented in the ticket group 1 and the service tickets represented in the ticket group 2.

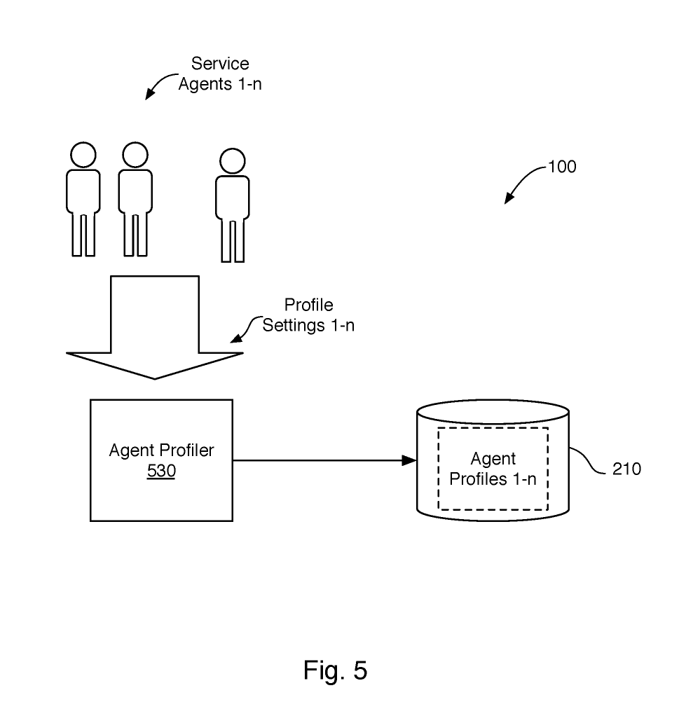

FIG. 5 illustrates an agent profiler 530 in one or more embodiments of the service deployment system 100. The agent profiler 530 obtains a set of profile settings 1-n for the agent profiles 1-n from the service agents 1-n. For example, the agent profiler 530 obtains the profile settings 1 for the agent profile 1 from the service agent 1, and obtains the profile settings 2 for the agent profile 2 from the service agent 2, etc. In one or more embodiments, the agent profiler 530 generates a user interface that enables the service agents 1-n to enter their skills, select predetermined skills from lists, select notify, distribute preferences, etc., using e.g., a computer, mobile device, etc.

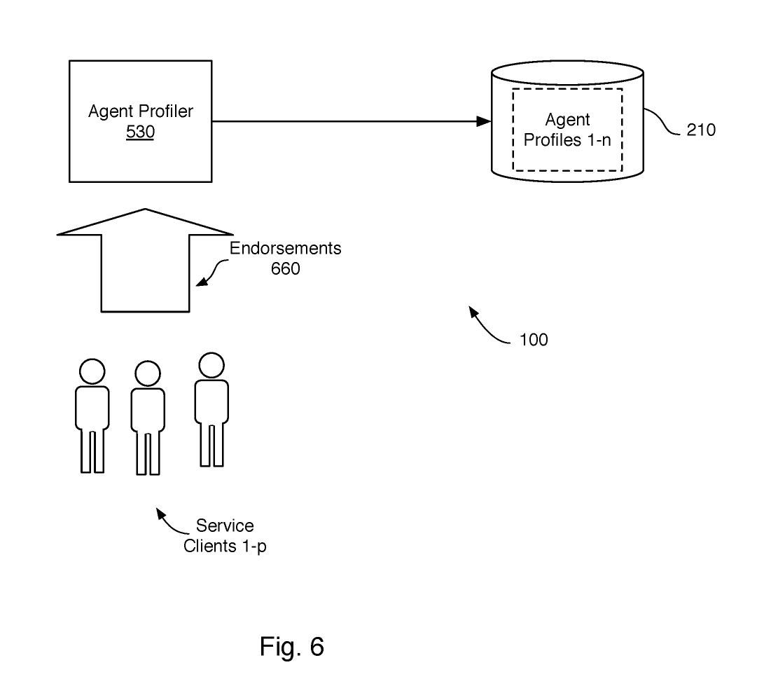

FIG. 6 illustrates an embodiment in which the agent profiler 530 obtains a set of endorsements 660 for the agent profiles 1-n from the service clients 1-p. The endorsements 660 enable the service clients 1-p to endorse, rate, etc., the skills of the service agents 1-n.

For example, the service clients 1-p may have previously submitted service tickets to the service deployment system 100 and so have experience with the skills and competence of one or more of the service agents 1-n. In one or more embodiments, the agent profiler 530 generates a user interface on devices e.g., computers, mobile devices, etc., of the service clients 1-p that enables the service clients 1-p to enter skills for one or more of the service agents 1-n, select from among a set of predetermined ratings of the skills of the service agents 1-n, etc. In one or more embodiments, the agent profiler 530 also enables the service agents 1-n to enter endorsements.

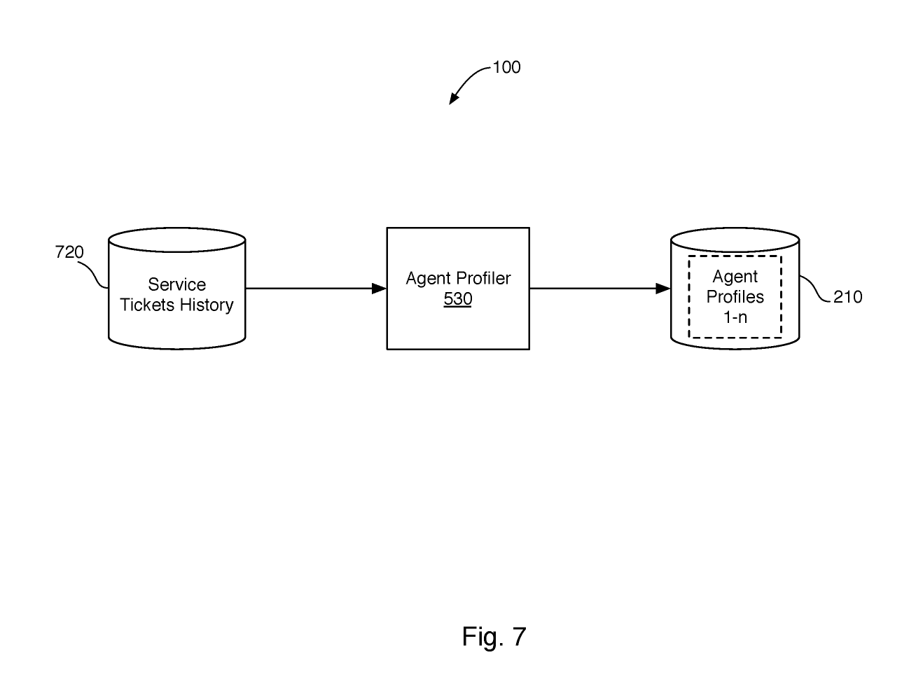

FIG. 7 illustrates an embodiment in which the agent profiler 530 obtains one or more skills for the agent profiles 1-n by data mining the content of a set of service tickets recorded in a service tickets history 720. The service tickets history 720 provides a record of service tickets previously handled by one or more of the service agents 1-n. For example, the agent profiler 530 can detect keywords, phrases, features, etc., in a set of previous service tickets handled by the service agent 1 that are relevant to the health benefits skills and then record the health benefits skills in the agent profile 1. Likewise, the agent profiler 530 can detect data in a set of previous service tickets handled by the service agent 2 that are relevant to the bonus structures skills and then record the bonus structures skills in the agent profile 2.

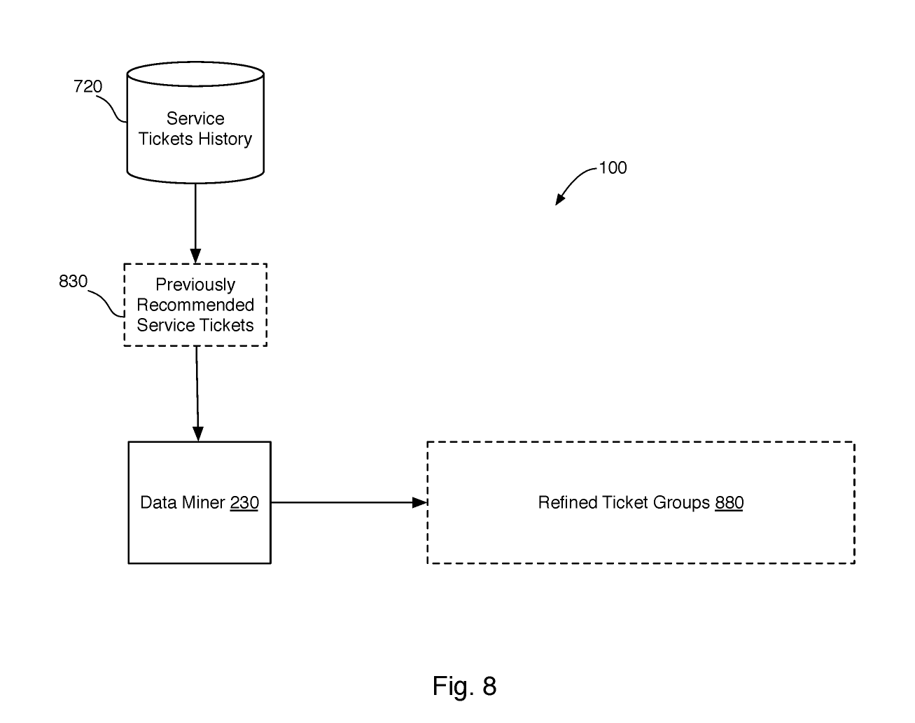

FIG. 8 illustrates an embodiment in which the data miner 230 refines the ticket groups 1-x (FIG. 2) in response to a set of previously recommended service tickets 830 from the service tickets history 720. For example, if the ticket group 1 currently matches to the service agent 1, the data miner 230 can extract features from one or more of the previously recommended service tickets 830 for the service agent 1 and compare those features to the features of the current ticket group 1. If the features extracted from the previously recommended service tickets 830 of the service agent 1 are not a good match to the current ticket group 1, the data miner 230 refines the ticket group 1. For example, the data miner 230 can generate a set of refined ticket groups 880 by adjusting one or more weights of the features extracted from the service tickets 1-m, running additional learning iterations, altering fitness functions, etc.

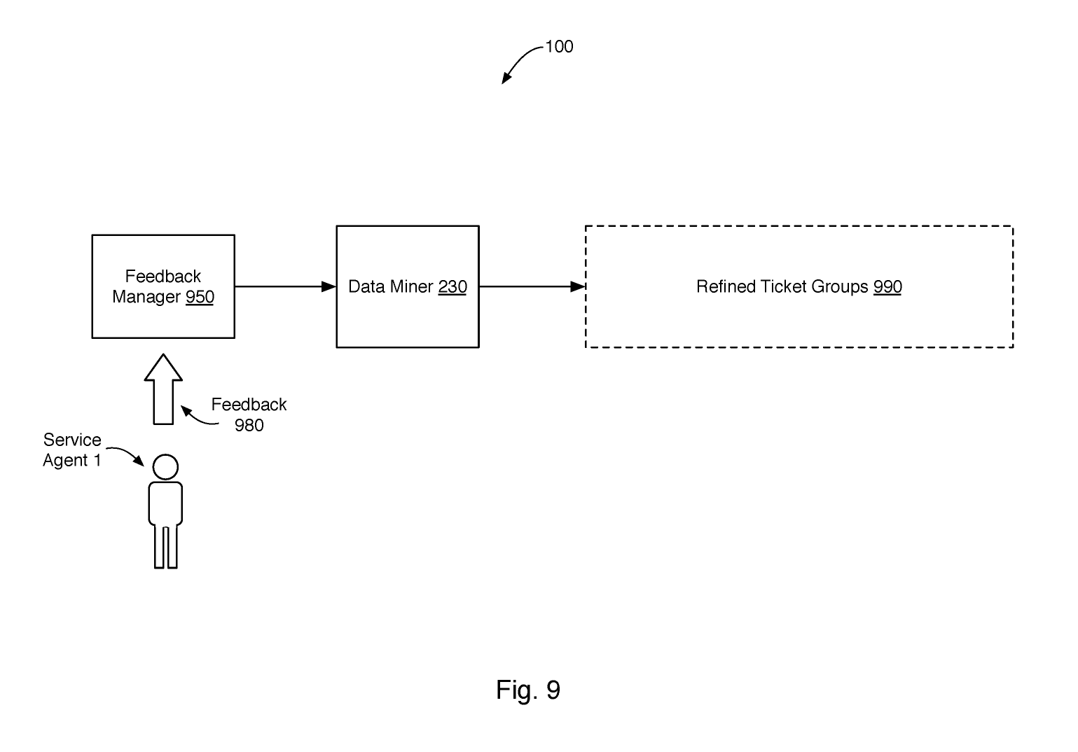

FIG. 9 illustrates an embodiment in which the data miner 230 refines the ticket groups 1-x (FIG. 2) in response to feedback from the service agents 1-n. In this example, a feedback manager 950 in the service deployment system 100 obtains a feedback 980 from the service agent 1 indicating whether or not the service agent 1 agrees with their recommendation 1. In one or more embodiments, the feedback 980 is a yes or a no indication. In other embodiments, the feedback 980 is a rating, e.g., a rating selected by the service agent 1 from a set of predetermined rating levels of agreement/disagreement.

The data miner 230 refines the current ticket groups 1-x into a set of refined ticket groups 990 in response to the feedback 980. For example, the data miner 230 can generate the refined ticket groups 990 by adjusting one or more weights of the features extracted from the service tickets 1-m, by running additional learning iterations, by altering fitness functions, etc.

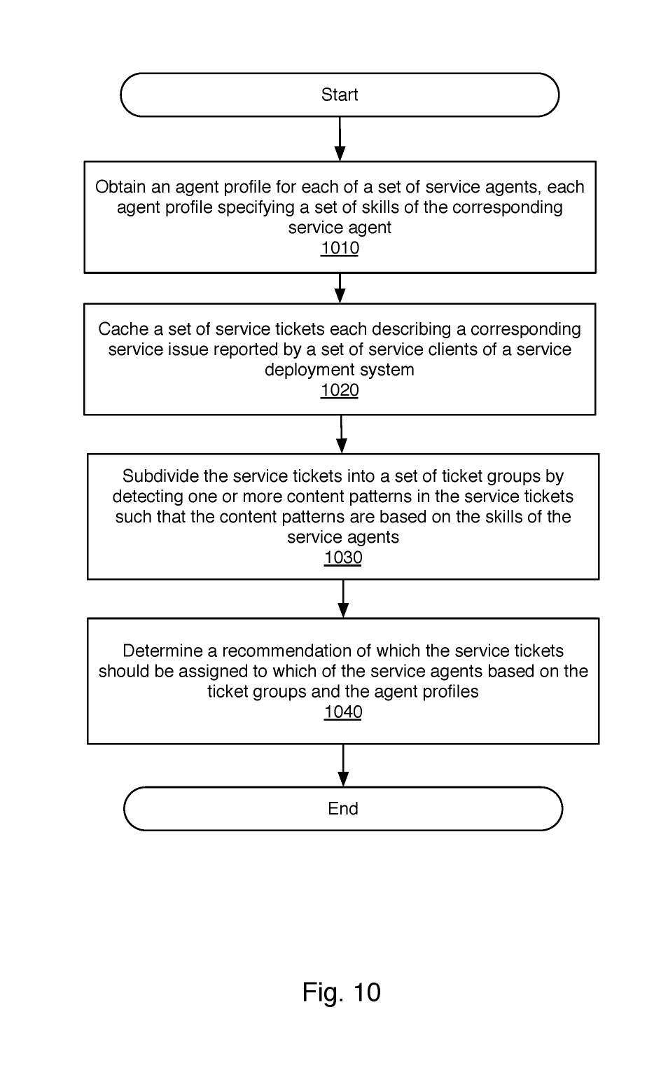

FIG. 10 illustrates a method for service deployment based on service ticket data mining and agent profiles for in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 10 should not be construed as limiting the scope of the invention.

At step 1010, an agent profile is obtained for each of a set of service agents of a service deployment system. Each agent profile specifies a set of skills of the corresponding service agent. The skills can be obtained from the service agents or from clients of the service deployment system or can be inferred from a ticket handling history of the service agents, or a combination.

At step 1020, a set of service tickets are cached. Each service ticket describes a corresponding service issue reported by a service client of the service deployment system. Caching of the service tickets enables data mining on the information in the service tickets.

At step 1030, the cached service tickets are subdivided into a set of ticket groups by detecting one or more content patterns in the service tickets such that the content patterns are based on the skills of the service agents. The service tickets can be subdivided using one or more clustering techniques, e.g., spectral clustering, deep learning, neural networks, etc.

At step 1040, a recommendation is determined of which the cached service tickets should be assigned to which of the service agents based on the ticket groups and the agent profiles. For example, a set of skills features associated with each ticket group can be mapped to the skills in the agent profiles of the service agents.

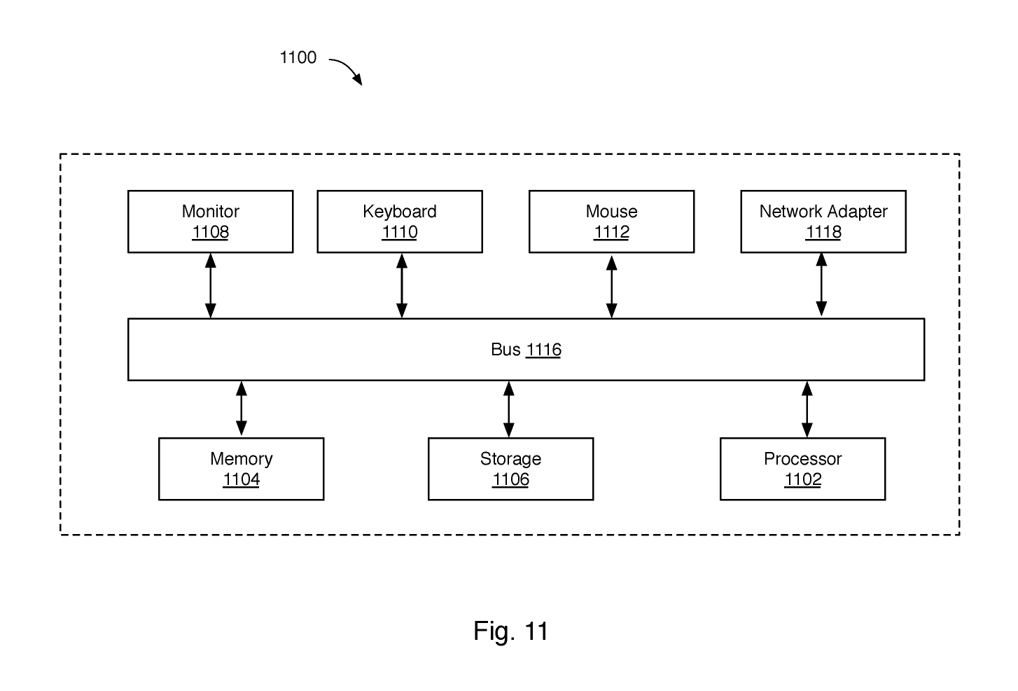

FIG. 11 illustrates a computing system 1100 upon which portions of the service deployment system 100 can be implemented. The computing system 1100 includes one or more computer processor(s) 1102, associated memory 1104 (e.g., random access memory (RAM), cache memory, flash memory, etc.), one or more storage device(s) 1106 (e.g., a hard disk, an optical drive such as a compact disk (CD) drive or digital versatile disk (DVD) drive, a flash memory stick, etc.), a bus 1116, and numerous other elements and functionalities. The computer processor(s) 1102 may be an integrated circuit for processing instructions. For example, the computer processor(s) may be one or more cores or micro-cores of a processor. The computing system 1100 may also include one or more input device(s), e.g., a touchscreen, keyboard 1110, mouse 1112, microphone, touchpad, electronic pen, or any other type of input device. Further, the computing system 1100 may include one or more monitor device(s) 1108, such as a screen (e.g., a liquid crystal display (LCD), a plasma display, touchscreen, cathode ray tube (CRT) monitor, projector, or other display device), external storage, input for an electric instrument, or any other output device. The computing system 1100 may be connected to, e.g., a local area network (LAN), a wide area network (WAN) such as the Internet, mobile network, or any other type of network) via a network adapter 1118.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A service deployment system, comprising:
a data store for holding an agent profile for each of a set of service agents, each agent profile specifying a set of skills of the corresponding service agent;
a cache of set of service tickets each describing a corresponding service issue reported by a set of service clients of the service deployment system;
a data miner for subdividing the service tickets into a set of ticket groups by detecting one or more content patterns in the service tickets such that the content patterns are based on the skills of the service agents; and
an agent mapper for determining a recommendation of which the service tickets should be assigned to which of the service agents based on the ticket groups and the agent profiles.

2. The service deployment system of claim 1, further comprising a notifier for notifying the service agents of the recommendations.

3. The service deployment system of claim 1, further comprising a distributor for distributing the service tickets to the service agents in response to the recommendations.

4. The service deployment system of claim 1, wherein the data miner detects the content patterns by extracting a set of features from each service ticket and clustering the service tickets in response to the features.

5. The service deployment system of claim 1, further comprising an agent profiler that obtains at least one of the skills for the agent profiles from the corresponding service agent.

6. The service deployment system of claim 1, further comprising an agent profiler that obtains at least one of the skills for the agent profiles from one or more of the service clients.

7. The service deployment system of claim 1, further comprising an agent profiler that determines at least one of the skills for the agent profiles by analyzing a set of service tickets previously handled by the service agents.

8. The service deployment system of claim 1, wherein the data miner refines the ticket groups in response to a set of service tickets previously handled by one or more of the service agents.

9. The service deployment system of claim 1, wherein the data miner refines the ticket groups in response to a feedback obtained from one or more of the service agents.

10. The service deployment system of claim 1, further comprising an agent profiler that enables each service agent to specify a respective preference for how the respective recommendation will be provided to the respective service agent.

11. A method for service deployment, comprising:
obtaining an agent profile for each of a set of service agents, each agent profile specifying a set of skills of the corresponding service agent;
caching a set of service tickets each describing a corresponding service issue reported by a set of service clients of a service deployment system;
subdividing the service tickets into a set of ticket groups by detecting one or more content patterns in the service tickets such that the content patterns are based on the skills of the service agents; and
determining a recommendation of which the service tickets should be assigned to which of the service agents based on the ticket groups and the agent profiles.

12. The method of claim 11, further comprising notifying the service agents of the recommendations.

13. The method of claim 11, further comprising distributing the service tickets to the service agents in response to the recommendations.

14. The method of claim 11, wherein detecting one or more content patterns in the service tickets comprises extracting a set of features from each service ticket and clustering the service tickets in response to the features.

15. The method of claim 11, wherein obtaining an agent profile for each of a set of service agents comprises obtaining at least one of the skills for the agent profiles from the corresponding service agent.

16. The method of claim 11, wherein obtaining an agent profile for each of a set of service agents comprises obtaining at least one of the skills for the agent profiles from one or more of the service clients.

17. The method of claim 11, wherein obtaining an agent profile for each of a set of service agents comprises determining at least one of the skills for the agent profiles by analyzing a set of service tickets previously handled by the service agents.

18. The method of claim 11, further comprising refining the ticket groups in response to a set of service tickets previously handled by one or more of the service agents.

19. The method of claim 11, further comprising refining the ticket groups in response to a feedback obtained from one or more of the service agents.

20. The method of claim 11, further comprising obtaining a respective preference from one or more of the service agents indicating how the respective recommendation will be provided to the respective service agent.
